(19) United States
(12) Patent Application Publication
(10) Pub. No.: US 2012/0293096 A1
(43) Pub. Date: Nov. 22, 2012

(54) Power Tool and Battery Pack for Use Therein

(75) Inventors: Toshio Mizoguchi, Hitachinaka-shi (JP); Shinji Watanabe, Hitachinaka-shi (JP)

(73) Assignee: HITACHI KOKI CO. LTD., Tokyo (JP)

(21) Appl. No.: 13/496,849

(22) PCT Filed: Feb. 2, 2011
(86) PCT No.: PCT/JP2011/052671

§ 371 Date: May 24, 2012

(30) Foreign Application Priority Data
Feb. 2, 2010 (JP) 2010-020984

(51) Int. Cl. H02P 7/06

(52) U.S. Cl. 318/139

(57) ABSTRACT

To prevent or suppress a secondary battery used in a power tool from being deteriorated, a battery property, such as internal resistance of the battery, and a battery status of the secondary battery, such as a voltage developed across the battery, are detected. Based on the battery property and the battery status as detected, a current flowing in the motor of the power tool is controlled.

### TECHNICAL FIELD

The present invention relates to a battery pack containing a rechargeable or secondary battery therein. The invention also relates to a battery-driven power tool having a battery deterioration suppressing capability.

### BACKGROUND ART

A battery-driven power tool drives a motor with a secondary battery contained in a battery pack. It is known that the secondary battery becomes deteriorated if the battery is over-discharged or overcurrent flows in the battery. In order to prevent the secondary battery from being deteriorated for these reasons, Japanese Laid-Open Patent Publication No. 2009-95162 proposes stopping power supply to the motor from the battery when it is determined that the battery is over-discharged or overcurrent flows in the battery.

### DISCLOSURE OF INVENTION

### Technical Problem

Despite the fact that the over-discharge and overcurrent are detected for the purpose of preventing the battery from being deteriorated, the goal cannot be achieved if detection of the over-discharge or overcurrent cannot be performed accurately. For example, delay in timing at which the power supply to the motor is stopped causes the battery to over-discharge. In the conventional power tools, the property of the battery is not taken into account notwithstanding the fact that the critical point of the over-discharge or overcurrent differs depending upon the property of the battery. The conventional power tools stop the power supply to the motor based on a fixed critical point, not on property-dependent critical point.

### Technical Solution

In view of the foregoing, it is an object of the invention to provide a battery-driven power tool and a battery pack for use therein, in which deterioration of a secondary battery contained in the battery pack does not substantially occur caused by the over-discharge of the battery or overcurrent flowing in a motor.

In order to achieve the above and other objects, there is provided a power tool that includes a connection portion, a motor, property/status detector, and a controller. To the connection portion, a battery pack is attachable. the battery pack contains a secondary battery characterized by a battery property and a battery status. The motor is supplied with power from the secondary battery. The property/status detector detects the battery property and the battery status. The controller controls a current flowing in the motor based on the battery property and the battery status detected by the property/status detector.

In the power tool defined as above, an over-discharge detector may further be provided that determines that the secondary battery is over-discharged when a voltage developed across the secondary battery falls below a first critical value. The first critical value is capable of being varied based on the battery property and the battery status detected by the property/status detector.

An over-current detector may further be provided that determines that an over-current is flowing in the motor when a current from the secondary battery has become equal to or exceeded a second critical value and halt supplying power to the motor. The second critical value is capable of being varied based on the battery property and the battery status detected by the property/status detector.

A storage unit may further be provided that stores a target current corresponding to the battery property and the battery status detected by the property/status detector. The controller controls the current flowing in the motor to be in coincidence with the target current.

According to another aspect of the invention, there is provided a battery pack for a power tool having a motor, the battery pack including a secondary battery, a property/status detector and a controller. The secondary battery is used as a power source of the motor. The secondary battery is characterized by a battery property and a battery status. The property/status detector detects the patter property and the battery status. The controller controls a current flowing in the motor based on the battery property and the battery status detected by the property/status detector.

In the battery pack defined as above, an over-discharge detector may further be provided that determines that the secondary battery is over-discharged when a voltage developed across the secondary battery falls below a first critical value. The first critical value is capable of being varied based on the battery property and the battery status detected by the property/status detector.

An over-current detector may further be provided in the battery pack as defined above for determining that an over-current is flowing in the motor when a current from the secondary battery has become equal to or exceeded a second critical value and halt supplying power to the motor. The second critical value is capable of being varied based on the battery property and the battery status detected by the property/status detector.

A storage unit may further be provided in the battery pack defined as above for storing a target current corresponding to the battery property and the battery status detected by the property/status detector. The controller controls the current flowing in the motor to be in coincidence with the target current.

The term “battery property” as used herein encompasses an internal resistance of the secondary battery and a rated voltage of the secondary battery. The term “battery status” as used herein encompasses a voltage across the second battery, and a temperature of the secondary battery.

### Advantageous Effects

With the control effected in accordance with the invention, deterioration of the secondary battery caused by over-discharge and/or overcurrent can be effectively suppressed.

### BRIEF DESCRIPTION OF DRAWINGS

The particular features and advantages of the invention as well as other objects will become apparent from the following description taken in connection with the accompanying drawings, in which:

FIG. 1 is a vertical cross-sectional view showing a battery-driven driver drill (power tool) with a battery pack attached thereto according to an embodiment of the invention;

FIG. 2 is a circuit diagram showing electrical arrangements of the driver drill and battery pack; and

FIG. 3 is a graphical representation showing changes in battery temperature, battery voltage, and target and actual current flowing in the motor of the power tool.

### EXPLANATION OF REFERENCE

1: driver drill (power tool)
2: battery pack
12: motor
14: FET (switching element)
17: tool-side controller
22: secondary battery
22a: battery cell
23: battery property detecting resistor
24: thermistor (battery temperature detecting element)
25: current detecting resistor
26: battery-side controller
26a: memory
26b: microcomputer

### BEST MODE FOR CARRYING OUT THE INVENTION

An embodiment of the invention will be described with reference to the accompanying drawings.

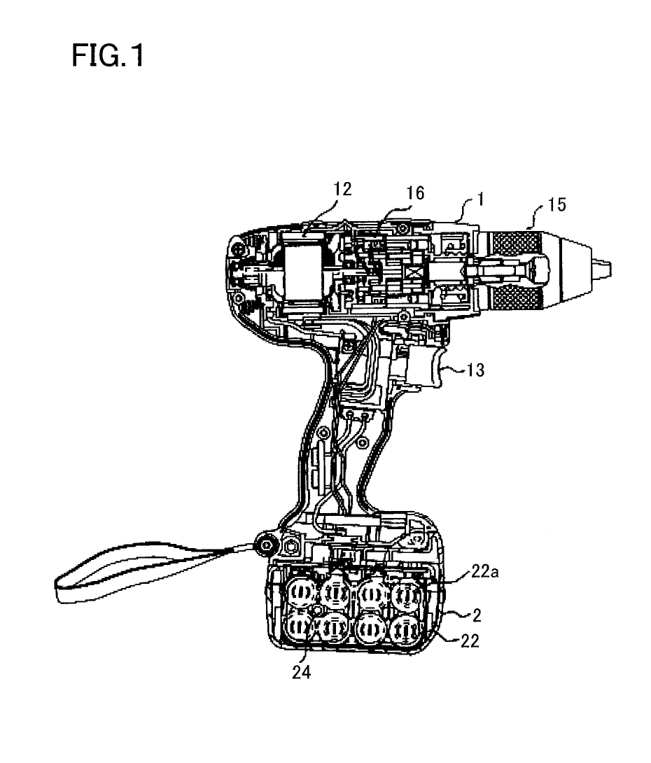

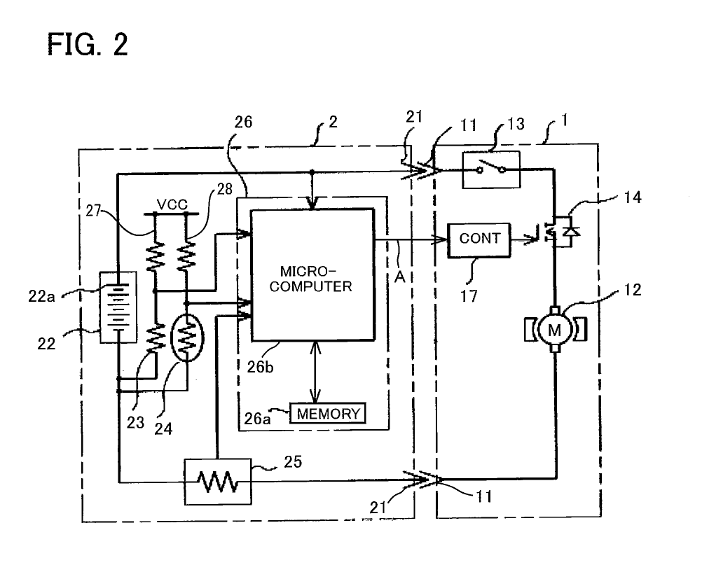

FIG. 1 shows a battery-driven driver drill 1 and a battery pack 2 attached to the bottom end of the driver drill 1. In this embodiment, the driver drill is taken as an example of a power tool. The power tool encompasses the driver drill, a screw driver, an impact driver, a drill or the like. As shown in FIG. 2, the driver drill 1 has a pair of tool-side terminals 11 and the battery pack 2 has a pair of battery-side terminals 21. Connection of the tool-side and battery-side terminals 11, 12 can be accomplished when the battery pack 2 is fitted and attached to the screw driver 1.

The driver drill 1 includes a motor 12 and a mechanical section 16. The input side of the mechanical section 16 is coupled to the motor 12 and an output side to a chuck 15 to which a bit is detachably attached. The mechanical section 16 transmits rotational power of the motor 12 to the chuck 15 so that a screw is tightened into a workpiece by the bit held on the chuck. The driver drill 1 is provided with a trigger switch 13. When the trigger switch 13 is in a fully projected state, i.e., the switch 13 is OFF, the motor 12 is electrically disconnected from the battery pack 2 and hence the screw driver 1 is not driven. When the trigger switch 13 is pulled inward by an operator's finger, i.e., the switch 13 is ON, the motor 12 is electrically connected to the battery pack 2, allowing the motor 12 to rotate.

An electrical arrangement of the driver drill 1 is shown in FIG. 2. As shown, the driver drill 1 includes a controller 17 and an N-type FET 14 serving as a switching element whose switching actions are controlled by the controller 17. The FET 14 is provided with a diode whose anode is connected to the source of the FET 14 and cathode to the drain of the FET 14 to allow current to flow backward with respect to a direction in which discharge current flows.

As shown in FIGS. 1 and 2, the battery pack 2 includes a rechargeable or secondary battery 22 consisting of a plurality of battery cells 22a connected in series. The battery 22 may be a nickel-cadmium battery, a nickel metal hydride battery, or a lithium ion battery. As shown in FIG. 2, the battery pack 2 includes resistors 23, 25 and 27-28, a thermistor 24, and a controller 26. The resistor 25 is connected in a discharge current flowing path and serves to detect the discharge current in cooperation with the controller 26. The resistors 27 and 23 are connected in series between the power supply Vcc and the negative terminal of the battery 22. The voltage developed across the resistor 23 is applied to the controller 26. The resistor 23 has a specific resistance indicative of the property of the battery 22 contained in the battery pack 2. The property of the battery 22 encompasses a manufacturer of the battery pack 2, and the type of the battery (nickel-cadmium battery, nickel metal hydride battery, or lithium ion battery). The resistor 28 and the thermistor 24 are connected in series between the power supply Vcc and the negative terminal of the battery 22. The thermistor 24 is a type of resistor whose resistance varies significantly with temperature. The thermistor 24 is disposed in contact with or in the vicinity of the battery 2 to detect the temperature of the battery. Thus, the thermistor 23 serves as a battery temperature detecting element. The voltage developed across the thermistor 24 is applied to the controller 26.

The controller 26 includes a memory 26a and a microcomputer 26b. The memory 26a and the microcomputer 26b are mutually connected to each other via a bus. The memory 26a stores information about the battery property, target current levels suitable for both the battery property and a battery status, and critical values for determining over-discharge and overcurrent. Identification of the manufacturer indicates an internal resistance of the battery 22. Identifications of the type of the battery and the manufacturer indicate a rated voltage of the battery 22. Parameters for the battery status include battery voltage and battery temperature (or internal resistance of the battery 22).

The output from the battery-side controller 26 is applied to the tool-side controller 17 via a communication path A. To the battery-side controller 26, applied are a battery property signal from the battery property detecting resistor 23, a battery temperature signal from the thermistor 24, and a current signal from the current detecting resistor 25. Further, the microcomputer 26b detects the voltage across the battery 22. Referring to the memory 26a, the microcomputer 26b sets a target current level suitable for both the battery property and the battery status, and transmits the target current level thus set to the tool-side controller 17 through the communication path A. The tool-side controller 17 implements a PWM control so that the target current flows in the motor 12. That is, the controller 17 controls an ON/OFF duty ratio of the FET 14 so that current corresponding to the target current flows in the motor 12. With such a control, a load current determined while taking the battery property and the battery status into account flows in the motor 12. The battery property refers to a battery behavior dependent upon internal resistance of the battery 22, temperature of the battery 22, rated voltage of the battery 22, for example. The battery status refers, for example, to voltage across the battery 22 or the remaining capacity of the battery 22, battery temperature, and so on.

Next, description will be made with respect to the level of target current to be stored in the memory 26a.

With respect to the parameter of the battery property, the battery 22 generates heat when current flows therein due to the internal resistance of the battery 22. The more the amount of heat generated from the battery 22 increases, the more the battery 22 is liable to be damaged. The amount of heat generated from the battery 22 changes with both the internal resistance of the battery 22 and the current flowing therein. Different manufacturers produce batteries of different internal resistances. Accordingly, a low-level target current is stored in the memory 26a for a battery having a large internal resistance whereas a high-level target current is stored in the memory 26a for a battery having a small internal resistance.

The rated voltage of a battery 22 changes with the type or kind of the battery. The higher the rated voltage is, the larger the current can be flowed in the battery 22. Accordingly, a high-level target current is stored in the memory 26a for a high rated voltage battery, such as 3.6V rated voltage lithium-ion battery whereas a low-level target current is stored in the memory 26a for a low rated voltage battery, such as 1.2V rated voltage nickel-cadmium battery or 1.2V rated voltage nickel metal hydride battery.

With respect to the parameter of the batter status, when the battery voltage is high, heat generated from the battery increases due to the internal resistance. Accordingly, a low-level target current is stored in the memory 26a for a battery whose voltage is high whereas a high-level target current is stored in the memory 26a for a battery whose voltage is low.

Generally, the internal resistance of the battery increases when the temperature of the battery is lowered, resulting in generation of a large amount of heat when a high-level current flows in the battery. When the temperature of the battery increases, the amount of heat generated from the battery also increases. As such, a high-level target current is stored in the memory 26a for the battery whose temperature is within a predetermined range. However, for the battery whose temperature is out of the predetermined range, a low-level target current is stored in the memory 26a.

The microcomputer 26 accesses to the memory 26a and retrieves four target currents including a target current corresponding to the internal resistance of the battery 22, a target current corresponding to the rated voltage of the battery 22, a target current corresponding to the battery voltage, and a target current corresponding to a battery temperature. The microcomputer 26b computes an average of the above four target currents. The averaged target current is used as an actual target current which can effectively prevent the battery 22 from being deteriorated and bring out the capability of the battery 22 with no substantial damage.

| | Parameter | | Target current |
|---|---|---|---|
| Battery | Internal resistance | Large | Small |
| property | | Small | Large |
| | Rated voltage | Large (3.6 V/cell) | Large |
| | | Small (1.2 V/cell) | Small |
| Battery | Battery voltage | Large | Small |
| status | | Small | Large |
| | Battery temperature | Inside of range | Large |
| | | Outside of range | Small |

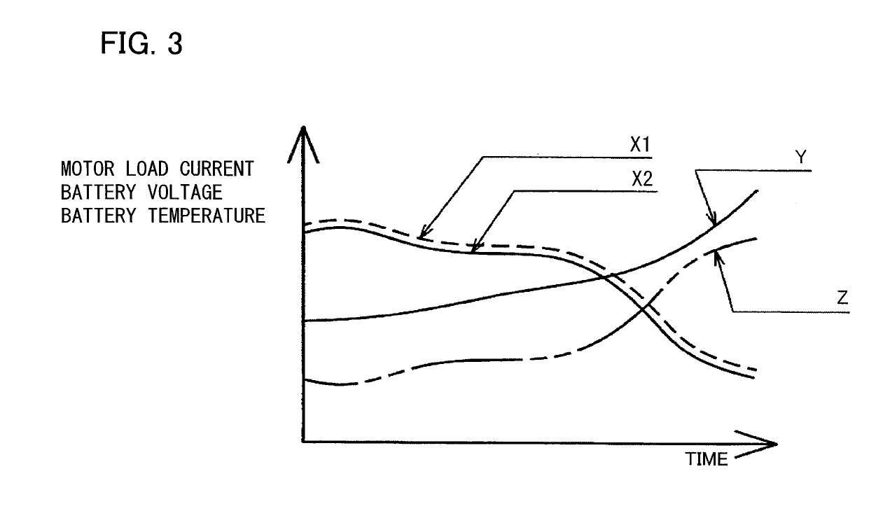

FIG. 3 shows an effect of the current control as described above in which changes in each of the motor load current, battery voltage and battery temperature are exemplified when the driver drill 1 is continuously driven. In FIG. 3, the curve “X2” represents an actual load current; the curve “X1” a target current; the curve “Y” battery temperature; and the curve “Z” battery voltage. As shown in FIG. 3, the battery temperature (Y) gradually increases as the power of the motor 12 increases. The battery voltage (Z) is depicted to gradually increase as the time passes. It is for this reason that as shown, the actual load current deceases as the time passes, so that the voltage drop caused by the internal resistance of the battery gradually decreases. As a result, the battery voltage gradually returns to its rated voltage. The graphs represent a state in which heated generated by the internal resistance of the battery is gradually increasing.

The memory 26a stores the low-level target currents for high battery voltage and also for the battery whose temperature is out of the predetermined range. Therefore, the actual load current “X2” (actual target current) is controlled to decrease.

The microcomputer 26b determines that the battery has been over-discharged when the battery voltage falls below a first critical value and also determines that an overcurrent is flowing when the current flowing in the motor 12 has become equal to or exceeds a second critical value. In any of these cases, a discharge stop signal is applied to the tool-side controller 17.

The memory 26b according to this embodiment stores a plurality of critical values for determining the over-discharge and the overcurrent flowing conditions. The plurality of critical values is prepared to be suitable for different battery properties and different the battery statuses. The microcomputer 26b changes or selects one of the critical values relevant to the battery property and the outstanding battery status.

The critical value stored in the memory 26a for determining the overcurrent condition is set to a large value with respect to the high rated voltage battery. On the other hand, the critical value stored in the memory 26a for determining the overcurrent condition is set to a small value with respect to the low rated voltage battery. The microcomputer 26b accesses the memory 26a and selects a relevant critical value corresponding to the rated voltage of the battery. By controlling the current flowing from the battery in accordance with the selected critical value, deterioration of the battery which may be caused by the overcurrent flowing from the battery can be prevented.

Another critical value stored in the memory 26a for determining the overcurrent condition is set to a small value with respect to the battery having a large internal resistance. On the other hand, the critical value stored in the memory 26a for determining the overcurrent condition is set to a large value with respect to the battery having a small internal resistance. The microcomputer 26b accesses the memory 26a and selects a relevant critical value corresponding to the internal resistance of the battery. By controlling the current flowing from the battery in accordance with the selected critical value, deterioration of the battery which may be caused by the overcurrent flowing from the battery can be prevented.

| Parameter | | Critical value |
|---|---|---|
| Rated voltage | Large | Large |
| | Small | Small |
| Internal resistance | Large | Small |
| | Small | Large |

As described above, the current flowing in the motor 12 is controlled while taking the battery property and the battery status into account, deterioration of the battery caused by over-discharge can be prevented or suppressed. Further, the use of the battery can be carried out effectively without exceeding possible power supply capability. For example, because the current flowing in the motor can be controlled to be small with respect to the battery having a large internal resistance, the battery can be prevented from being deteriorated caused by the overcurrent. On the other hand, because the current flowing in the motor is controlled to be large with respect to the battery having a small internal resistance, the power supply capability of the battery can be set to maximum without deteriorating the battery.

Further, critical values for determining the over-discharge and overcurrent are changed depending upon the battery property and/or battery status, thereby effectively preventing the battery from being deteriorated.

The memory 26a stores target currents suitable for the battery property and the outstanding battery status, determination of the relevant current to flow in the motor can be easily made only by referring to the data stored in the memory 26a.

While the invention has been described in detail with reference to a specific embodiment thereof, it would be apparent to those skilled in the art that various changes and modifications may be made therein without departing from the spirit of the invention.

For example, the battery status may encompass how many times the battery is recharged. The internal resistance of the battery 22 increases as the number of times the battery 22 is recharged increases. When the parameter regarding the number of times the battery is recharged is taken into account, the target current needs to be set to a small value with respect to the battery that has been recharged for many times. On the other hand, for the batteries that has not been recharged for many times, a large target current needs to be stored in the memory 26a.

| | Parameter | | Target current |
|---|---|---|---|
| Battery status | Recharged number | Small | Large |
| | of times | Large | Small |
| | Continuously driven | Long | Small |
| | time duration | Short | Large |

The battery temperature increases as the period of time the power tool 1 is continuously driven prolongs. Accordingly, the continuously driven time period of the power tool 1 may be used as a parameter of the battery status in place of the battery temperature.

In the above-described embodiment, the microcomputer 26b determines a target current based on an average of the parameters representing the battery property and the battery status. Among the various target currents corresponding to various parameters, the smallest target current may be selected if suppressing the battery deterioration is considered to be most important. Further, all the available parameters may not be used. That is, one or more, but not all, of the parameters may not be employed to determine the target current and the critical value for determining the over-discharge or overcurrent condition. In the above-described embodiment, the microcomputer 26b for determining the target current and selecting critical values is provided in the battery pack side. However, the microcomputer 26b having such a function may be provided in the power tool side.

1. A power tool comprising:
a connection portion to which a battery pack containing a secondary battery is attachable, the secondary battery being characterized by a battery property and a battery status;
a motor supplied with power from the secondary battery;
a property/status detector that is configured to detect the battery property and the battery status; and
a controller that is configured to control a current flowing in the motor based on the battery property and the battery status detected by the property/status detector.

2. The power tool according to claim 1, further comprising an over-discharge detector that is configured to determine that the secondary battery is over-discharged when a voltage developed across the secondary battery falls below a first critical value, wherein the first critical value is capable of being varied based on the battery property and the battery status detected by the property/status detector.

3. The power tool according to claim 1 or 2, further comprising an over-current detector that is configured to determine that an over-current is flowing in the motor when a current from the secondary battery has become equal to or exceeded a second critical value and halt supplying power to the motor, wherein the second critical value is capable of being varied based on the battery property and the battery status detected by the property/status detector.

4. The power tool according to claim 1 or 2, further comprising a storage unit that stores a target current corresponding to the battery property and the battery status detected by the property/status detector, wherein the controller controls the current flowing in the motor to be in coincidence with the target current.

5. The power tool according to claim 1, wherein the battery property encompasses an internal resistance of the secondary battery and a rated voltage of the secondary battery.

6. The power tool according to claim 1, wherein the battery status encompasses a voltage across the second battery, and a temperature of the secondary battery.

7. A battery pack for a power tool having a motor, the battery pack comprising:
a secondary battery used as a power source of the motor, the secondary battery being characterized by a battery property and a battery status;
a property/status detector that is configured to detect the patter property and the battery status; and
a controller that is configured to control a current flowing in the motor based on the battery property and the battery status detected by the property/status detector.

8. The battery pack according to claim 7, further comprising an over-discharge detector that is configured to determine that the secondary battery is over-discharged when a voltage developed across the secondary battery falls below a first critical value, wherein the first critical value is capable of being varied based on the battery property and the battery status detected by the property/status detector.

9. The battery pack according to claim 7 or 8, further comprising an over-current detector that is configured to determine that an over-current is flowing in the motor when a current from the secondary battery has become equal to or exceeded a second critical value and halt supplying power to the motor, wherein the second critical value is capable of being varied based on the battery property and the battery status detected by the property/status detector.

10. The battery pack according to claim 7 or 8, further comprising a storage unit that stores a target current corresponding to the battery property and the battery status detected by the property/status detector, wherein the controller controls the current flowing in the motor to be in coincidence with the target current.

11. The battery pack according to claim 7, wherein the battery property encompasses an internal resistance of the secondary battery and a rated voltage of the secondary battery.

12. The battery pack according to claim 7, wherein the battery status encompasses a voltage across the second battery, and a temperature of the secondary battery.
